(19) United States
(12) Patent Application Publication
(10) Pub. No.: US 2016/0048816 A1
(43) Pub. Date: Feb. 18, 2016

(54) Method and System for Processing Payment Transactions at an Automated Teller Machine

(71) Applicant: MasterCard International Incorporated, Purchase, NY (US)

(72) Inventor: Michael FRIEDMAN, Stamford, CT (US)

(73) Assignee: MasterCard International Incorporated, Purchase, NY (US)

(21) Appl. No.: 14/458,642

(22) Filed: Aug. 13, 2014

(51) Int. Cl. G06Q 20/10; G06Q 20/40

(52) U.S. Cl. CPC G06Q 20/1085; G06Q 20/40

(57) ABSTRACT

A method for processing payment transactions at an automated teller machine (ATM) includes: storing a plurality of account profiles, each profile including data related to a payment account associated with a consumer including a payment account number associated with the related payment account and one or more alternative account numbers, each associated with a different payment account associated with the consumer; reading payment details encoded on a payment card inserted in a receiving device of an ATM, the details including a specific payment account number; identifying a specific account profile where the included payment account number corresponds to the specific payment account number; and displaying a plurality of account selection items, each item corresponding to a payment account associated with one of: the payment account number and one of the one or more alternative account numbers included in the identified specific account profile.

### FIELD

The present disclosure relates to the presenting and processing transactions using an automated teller machine (ATM) as a point of sale (POS) terminal, specifically the identification of products based on imaging using an imaging device of an ATM and/or purchase thereof and/or the selection of one of a plurality of payment accounts to fund a transaction for processing at the ATM.

### BACKGROUND

In an effort to help aid bank customers at hours when banks were not open and in locations where banks were inconvenient or otherwise unavailable, ATMs were created and spread throughout the world, enabling customers to access account information, deposit checks or cash, withdrawal cash, and perform other aspects of account management. In many instances, ATMs read account details from a payment card, such as via a swipe of the payment card or insertion of the payment card into the ATM, and then enable the consumer to perform a variety of functions for the corresponding payment account.

However, ATMs often lack the ability to assist consumers with other functions outside of account management. For instance, ATMs are often placed in locations with high consumer traffic and in areas where consumers regularly conduct payment transactions for goods or services, such as in shopping malls, airports, department stores, etc. ATMs have several input devices useful for input and authentication, and are able to access account details, accept cash, dispense cash, print receipts, image users, and other useful functions, but are not currently used as a point of sale for the purchase of products.

Furthermore, many ATMs are associated with or in communication with a financial institution, such as one associated with a payment card provided by a consumer. However, in many instances ATMs are configured only to perform account management functions for account(s) directly corresponding to read payment card or cards, even in situations where the consumer may have additional payment accounts, beyond checking and savings, with the same financial institution.

In a different context, there is a present need to have secure point of sale terminals but demand for the sales may not justify the expense of having an additional point of sale, for instance, for dispensing tickets to an event.

Thus, there is a need for a technical solution that can utilize the hardware and functions of existing ATMs for use as a point of sale terminal in presenting and processing payment transactions for new and existing payment accounts of consumers.

### SUMMARY

The present disclosure provides a description of systems and methods for the presentation of products and processing of payment transactions using an automated teller machine.

A method for processing payment transactions at an automated teller machine (ATM) includes: storing, in an account database, a plurality of account profiles, wherein each account profile includes data related to a payment account associated with a consumer including at least a payment account number associated with the related payment account and one or more alternative account numbers, each associated with a different payment account associated with the consumer; reading, by a reading device, payment details encoded on a payment card inserted in a receiving device of an ATM, wherein the payment details include at least a specific payment account number; identifying, in the account database, a specific account profile where the included payment account number corresponds to the specific payment account number; and displaying, on a display device, a plurality of account selection items, wherein each account selection item corresponds to a payment account associated with one of: the payment account number and one of the one or more alternative account numbers included in the identified specific account profile.

A method for presenting products for purchase at an automated teller machine (ATM) includes: storing, in a product database, a plurality of product data entries, wherein each product data entry includes data related to a product available for purchase including at least a product identifier, product data, and one or more product characteristics; capturing, by an imaging device of an ATM, an image of a user of the ATM; analyzing, by a processing device, the captured image of the user of the ATM to identify a plurality of characteristics associated with the user of the ATM; identifying, in the product database, one or more product data entries based on a correspondence between the included one or more product characteristics and the identified plurality of characteristics; and displaying, by a display device, the product data included in each of the identified one or more product data entries to the user of the ATM for selection and purchase of the related product.

An automated teller machine (ATM) for processing payment transactions includes a receiving device, an account database, a reading device, a processing device, and a display device. The account database is configured to store a plurality of account profiles, wherein each account profile includes data related to a payment account associated with a consumer including at least a payment account number associated with the related payment account and one or more alternative account numbers, each associated with a different payment account associated with the consumer. The reading device is configured to read payment details encoded on a payment card inserted in the receiving device, wherein the payment details include at least a specific payment account number. The processing device is configured to identify, in the account database, a specific account profile where the included payment account number corresponds to the specific payment account number. The display device is configured to display a plurality of account selection items, wherein each account selection item corresponds to a payment account associated with one of: the payment account number and one of the one or more alternative account numbers included in the identified specific account profile.

A automated teller machine (ATM) for presenting products for purchase includes a product database, an imaging device, a processing device, and a display device. The product database is configured to store a plurality of product data entries, wherein each product data entry includes data related to a product available for purchase including at least a product identifier, product data, and one or more product characteristics. The imaging device is configured to capture an image of a user of the ATM. The processing device is configured to: analyze the captured image of the user of the ATM to identify a plurality of characteristics associated with the user of the ATM; and identify, in the product database, one or more product data entries based on a correspondence between the included one or more product characteristics and the identified plurality of characteristics. The display device is configured to display the product data included in each of the identified one or more product data entries to the user of the ATM for selection and purchase of the related product.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for presenting products for purchase and the processing of payment transactions in accordance with exemplary embodiments.

FIG. 2 is a block diagram illustrating the automated teller machine of FIG. 1 for presentation and processing of payment transactions in accordance with exemplary embodiments.

FIG. 3 is a flow diagram illustrating a process for the presentation of products for purchase based on captured images using the automated teller machine of FIG. 2 in accordance with exemplary embodiments.

FIG. 4 is a flow diagram illustrating a process for the processing of a payment transaction using a selected existing or new payment account via the automated teller machine of FIG. 2 in accordance with exemplary embodiments.

FIG. 5 is an illustration of a graphical user interface of the automated teller machine of FIG. 2 for the presentation of products based on captured images in accordance with exemplary embodiments.

FIG. 6 is an illustration of a graphical user interface of the automated teller machine of FIG. 2 for the selection of one of a plurality of payment accounts in accordance with exemplary embodiments.

FIG. 7 is an illustration of a graphical user interface of the automated teller machine of FIG. 2 for the use of a newly opened payment account in a payment transaction in accordance with exemplary embodiments.

FIG. 8 is a flow chart illustrating an exemplary method for the processing of payment transactions at an automated teller machine in accordance with exemplary embodiments.

FIG. 9 is a flow chart illustrating an exemplary method for presenting products for purchase at an automated teller machine in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Processing Payment Transactions Using an Automated Teller Machine

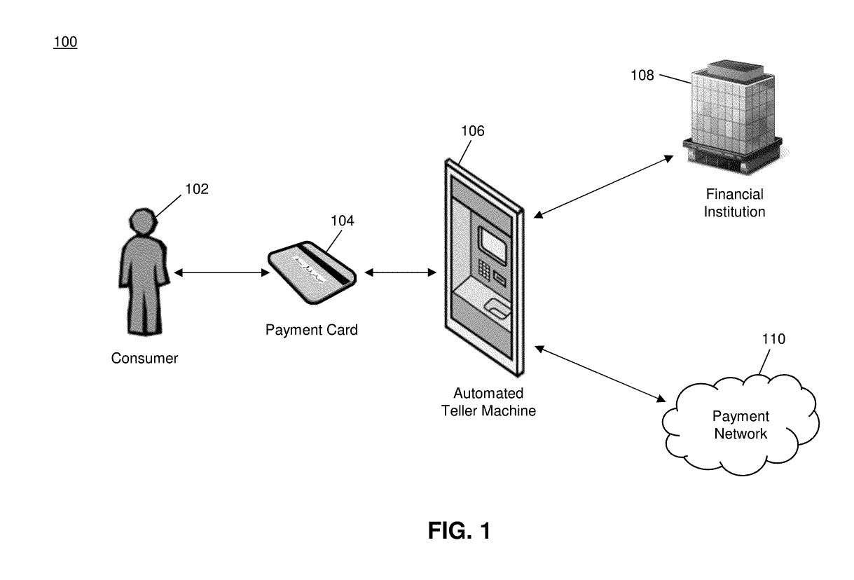

FIG. 1 illustrates a system 100 for the presentation of products for purchase and processing of payment transactions thereof using an automated teller machine (ATM).

The system 100 may include a consumer 102. The consumer 102 may possess a payment card 104, which may be issued to the consumer 102 and corresponding to a payment account. The payment account corresponding to the consumer 102 may be held by or otherwise associated with a financial institution 108, such as an issuing bank. The consumer 102 may use the payment card 104 at an ATM 106 to conduct payment transactions using the methods and systems discussed herein.

The ATM 106, discussed in more detail below, may be configured to present products for purchase to the consumer 102 and to process payment transactions. The ATM 106 may include an imaging unit or device, which may be configured to capture an image of the consumer 102 and associated objects. The ATM 106 may analyze the captured image to detect characteristics associated with the consumer 102 that may be suitable for the identification of products to present to the consumer 102. For instance, the ATM 106 may identify clothing or jewelry worn by the consumer 102 via image recognition and then present similar articles or goods to the consumer 102 for purchase, or advertisements held up to the camera by the consumer 102. In another instance, the ATM 106 may identify physical characteristics of the consumer 102 and identify products thereof, such as by identifying that the consumer 102 has long, curly hair and suggesting hair straighteners or special hair care products to the consumer 102 for purchase.

The ATM 106 may also be configured to enable the consumer 102 to select products for purchase. For example, the ATM 106 may include a product catalog that the consumer 102 may navigate through using one or more types of input, such as a keyboard, touch screen, microphone, etc. In another example, the ATM 106 may include a web browsing application program and may use websites to enable the consumer 102 to select products for purchase. In another embodiment, the ATM 106 may read a machine-readable code, such as a bar code, QR code, product order form, etc. that may be encoded with product or transaction details, which may initiate a payment transaction accordingly.

Once products have been selected, the ATM 106 may request payment details from the consumer 102 for funding of the payment transaction. The consumer 102 may present the payment card 104 to the ATM 106 for payment. The ATM 106 may read payment details encoded in the payment card 104 using methods that will be apparent to persons having skill in the relevant art. In some embodiments, the payment card 104 may be a mobile communication device, such as a smart phone, which may include payment details stored therein and transmitted to the ATM 106, such as via near field communication.

The ATM 106 may then contact the financial institution 108 associated with the payment account corresponding to the payment card 104 and verify the account details. The ATM 106 may also receive information from the financial institution 108 regarding additional payment accounts associated with the consumer 102 that the consumer 102 may have access to via the use of the payment card 104. The ATM 106 may then present the additional payment accounts along with the payment account corresponding to the payment card 104 to the consumer 102 for selection. The consumer 102 may select one of the available payment accounts for use in funding the payment transaction using an input device of the ATM 106.

In some embodiments, the ATM 106 may be configured to open a new payment account for use in funding the payment transaction upon request of the consumer 102. For example, among the available payment accounts presented to the consumer 102 may be an option to open a new payment account. When selected, the ATM 106 may transmit the request to the financial institution 108, which may open a new payment account or otherwise issue a new payment instrument to the consumer 102 for use in funding the payment transaction. In some instances, the financial institution 108 may provide terms for such a new payment instrument to the ATM 106 when first verifying the payment card 104.

In a further embodiment, the ATM 106 may be configured to print the new payment instrument using a printing device. For example, the ATM 106 may print a document indicating the opening of a new line of credit, may print a payment card encoded with payment details for a new payment account, etc. The consumer 102 may receive the payment instrument as confirmation of the newly opened payment account with the financial institution 108 to be used to fund the payment transaction.

Once a payment account has been selected, the ATM 106 may submit an authorization request for the payment transaction to a payment network 110 for processing using the selected payment account. The payment network 110 may then process the payment transaction using methods and systems that will be apparent to persons having skill in the relevant art. Once the transaction has been processed, an authorization response indicating approval or denial of the transaction may be transmitted back to the ATM 106, which may present the response to the consumer 102 and finalize the transaction accordingly. The ATM 106 may then transmit details regarding the transaction to the corresponding merchant, such as to notify the merchant that a sale has been made, what products were purchased, and how the products are to be delivered (e.g., shipped to the consumer 102, picked up at a specified location, etc.).

In some embodiments, the ATM 106 may be configured to print out a receipt for the payment transaction. In some instances, the ATM 106 may be configured to print out a voucher or ticket for the goods or services purchased by the consumer 102, which the consumer 102 may present to an associated merchant for redemption. In other instances, the ATM 106 may present a proof of purchase for the purchased products, or, in some cases, the products themselves. For example, if the consumer 102 purchases tickets for a nearby event, the ATM 106 may print the purchased tickets, which the consumer 102 may receive and then proceed to the event. In such an example, the ATM 106 may transmit a notification to the corresponding merchant that a set of tickets were purchased by the consumer 102.

The conversion of an ATM 106 into a point of sale for conducting and processing transactions may be beneficial for both consumers and merchants. ATMs 106 may thereby be used as a point of sale, which may enable small merchants and vendors to conduct payment transactions with consumers 102 without the need for purchasing and configuring a point of sale solution. For example, a vendor at a farmer's market may have the consumer 102 conduct a transaction for offered goods via the ATM 106, and then exchange the goods to the consumer 102 upon presentation of a voucher produced by the ATM 106 as part of the transaction.

The use of the ATM 106 may also be beneficial in conducting payment transactions in instances where the consumer 102 may be unable to immediately receive the purchased product and may be otherwise unable to transact. For example, a consumer 102 traveling in a foreign country may see a product they wish to purchase, but be unable to carry a product with them, and may be unable to use a mobile device to purchase such a product due to unavailable cellular service. The consumer 102 may use a nearby ATM 106 to purchase the product, which can then be shipped to the consumer's 102 address, which may be automatically available without user input via the financial institution 108, and may be waiting for the consumer 102 when they return. In another example, a consumer 102 on an airplane may view products in a magazine during a flight, and may mark an included order form of products they wish to purchase. Once landed at the airport, the consumer 102 may provide the order form to the ATM 106, which may read the order form and immediately initiate a payment transaction for the indicated products.

In addition, the ability for the consumer 102 to select from multiple payment accounts for use in a transaction at the ATM 106 may provide added benefits to the consumer 102. For instance, the consumer 102 may be able to conduct payment transactions across multiple payment accounts without the need to carry around multiple payment cards, and thus decrease the risk of fraud or theft. Furthermore, the ability to open new payment accounts and/or receive new payment instruments via the ATM 106 may also be of added benefit to the consumer 102.

### Automated Teller Machine

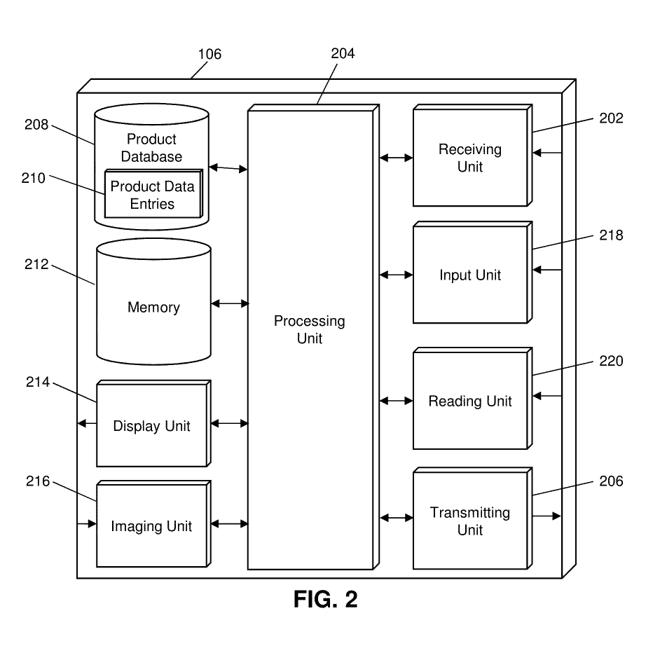

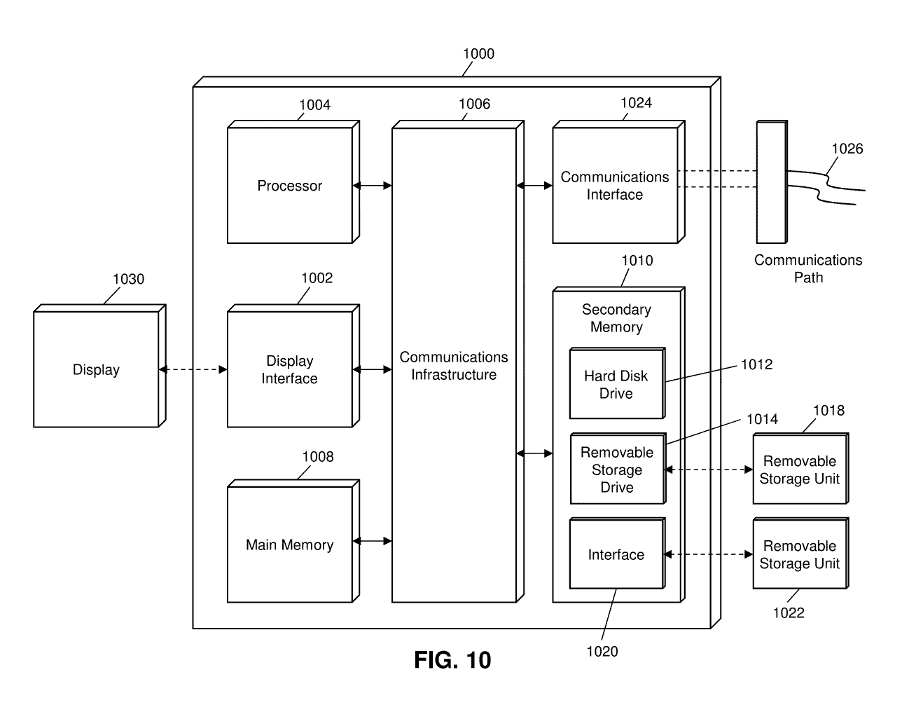

FIG. 2 illustrates an embodiment of the ATM 106 of the system 100. It will be apparent to persons having skill in the relevant art that the embodiment of the ATM 106 illustrated in FIG. 2 is provided as illustration only and may not be exhaustive to all possible configurations of the ATM 106 suitable for performing the functions as discussed herein. For example, the computer system 1000 illustrated in FIG. 10 and discussed in more detail below may be a suitable configuration of the ATM 106.

The ATM 106 may include a reading unit 220. The reading unit 220 may be configured to read the payment card 104 and payment details encoded thereof using methods that will be apparent to persons having skill in the relevant art. The ATM 106 may also include a receiving unit 202, which may be configured to receive payment details for the payment card 104, such as via near field communication from the payment card 104 or a mobile communication device configured to transmit payment details.

The ATM 106 may also include a transmitting unit 206. The transmitting unit 206 may be configured to transmit data over one or more networks via one or more network providers. The transmitting unit 206 may transmit the read and/or received payment details to the financial institution 108 associated with the payment card 104 for verification. The receiving unit 202 may be configured to receive data over one or more networks via one or more network protocols, and may be configured to receive a response from the financial institution 108. The response may include account details for the payment account associated with the payment card 104 as well as account details associated with other payment accounts associated with the consumer 102 that may be used to fund a payment transaction. In some embodiments, the response may also include account details for a proposed new payment account or payment instrument.

The ATM 106 may include a display unit 214, which may be configured to display a list of payment accounts to be selected by the consumer 102 that includes the payment account associated with the payment card 104, other available payment accounts, and/or any potential new payment accounts or payment instruments available to the consumer 102. The display unit 214 may be any type of display suitable for performing the functions disclosed herein, such as a liquid crystal display, light emitting diode display, capacitive touch display, thin film transistor display, etc.

The ATM 106 may also include an input unit 218. The input unit 218 may be configured to receive input from the consumer 102, such as for the selection of a payment account from the displayed list of payment accounts. The input unit 218 may be any type of unit or device suitable for receiving input from a user, such as a keyboard, mouse, click wheel, scroll wheel, touch screen, microphone, camera, etc. In some embodiments, the display unit 214 and input unit 218 may be the same unit or device. In some instances, the ATM 106 may include multiple input units 218.

The ATM 106 may further include an imaging unit 216. The imaging unit 216 may be configured to capture an image of an area near the ATM 106, such as an area including the consumer 102. The imaging unit 216 may be a camera or other unit or device suitable for the capturing of images. The ATM 106 may also include a processing unit 204. The processing unit 204 may be configured to perform the functions disclosed herein, including analyzing a captured image to identify one or more consumer characteristics. The one or more consumer characteristics may include products worn or used by the consumer 102 and/or other user, physical traits of the consumer 102 and/or other user, weather conditions, and additional characteristics that will be apparent to persons having skill in the relevant art.

The ATM 106 may further include a product database 208. The product database 208 may include a plurality of product data entries 210. Each product data entry 210 may include data related to a product available for purchase by the consumer 102 including at least a product identifier, product data, and one or more product characteristics. The processing unit 204 may be configured to identify one or more product data entries 210 in the product database 208 based on a correspondence between the product characteristics and the plurality of characteristics identified from analysis of the captured image. The display unit 214 may be configured to display the product data for the identified products to the consumer 102, and the input unit 218 may be configured to receive input from the consumer 102 selecting one or more of the products for purchase.

In some embodiments, the processing unit 204 may be configured to filter the product data entries 210 identified based on the correspondence between the characteristics identified in the captured image and the product characteristics. In some instances, the products may be filtered based on consumer data, such as provided by the consumer 102 or from the financial institution 108 and associated with the payment account corresponding to the payment card 104. For example, products may be filtered based on preferences of the consumer 102, the consumer's past purchase history, etc. Additional criteria used for filtering of products for presentation to the consumer 102 will be apparent to persons having skill in the relevant art.

The processing unit 204 may be further configured to generate an authorization request for a payment transaction. The authorization request may include transaction data based on the product or products selected by the consumer 102 for purchase and payment details associated with a payment account selected by the consumer 102. The transmitting unit 206 may be configured to transmit the generated authorization request to the payment network 110 for processing. The receiving unit 202 may be configured to receive an authorization response from the payment network 110 indicating approval or denial of the payment transaction. The display unit 214 may be configured to display the authorization response to the consumer 102. The transmitting unit 206 may be further configured to transmit the authorization response and any other transaction details regarding the payment transaction to the merchant involved in the payment transaction.

The ATM 106 may also include a memory 212. The memory 212 may be configured to store data suitable for performing the functions disclosed herein, such as account information received from the financial institution 108, transaction data for a payment transaction based on selections from the consumer 102, consumer data associated with consumers for the filtering of products, etc. In some embodiments, the ATM 106 may include an account database configured to store account profiles. Each account profile may include data related to a payment account for selection by the consumer 102, such as an account identifier associated with the related payment account. In some instances, each account profile may be associated with a consumer 102 and may include the plurality of account number suitable for selection by the consumer 102.

In one embodiment, the ATM 106 may also include a printing unit (not shown). The printing unit may be any type of unit or device suitable for the printing of receipts, vouchers, and/or payment instruments. The printing unit may be configured to print receipts for approved and process payment transactions, print vouchers suitable for redemption by the consumer 102 for purchased products, print purchased tickets or other printable products, print payment instruments corresponding to a newly issued payment account or instrument, etc. In some instances, the ATM 106 may be configured to print a payment card encoded with payment details corresponding to a newly opened payment account.

It will be apparent to persons having skill in the relevant art that the ATM 106 may include additional components suitable for performing the traditional functions of an automated teller machine, and/or that the components of the ATM 106 illustrated in FIG. 2 and discussed above may be further configured to perform the traditional functions of an automated teller machine. For example, the ATM 106 may include a dispensing unit configured to dispense currency (not shown), the input unit 218 or reading unit 220 may be configured to accept checks or deposit slips, etc.

### Process for Identifying and Presenting Products for Purchase

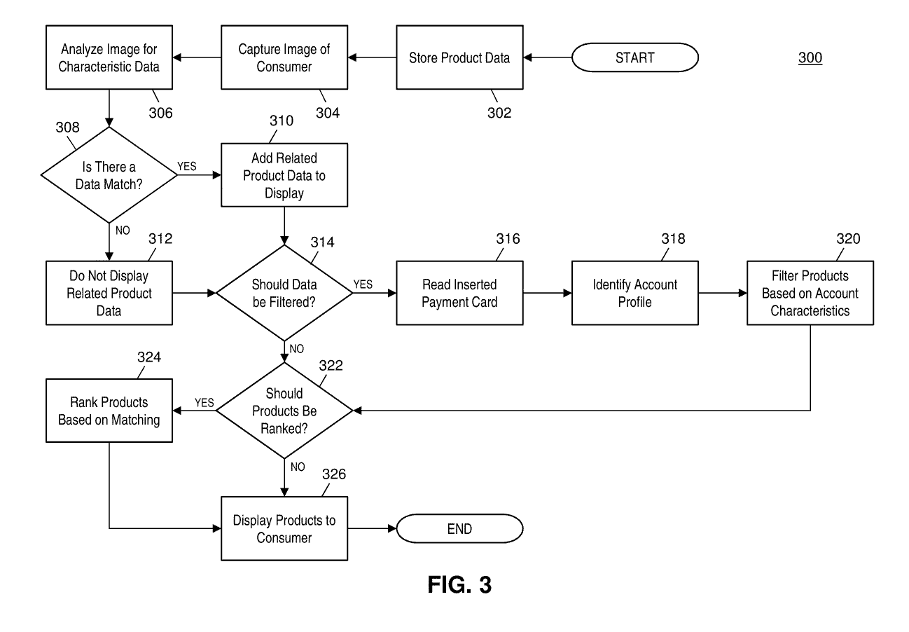

FIG. 3 illustrates a process 300 for the identification of products and presentation thereof for purchase at the ATM 106 based on a captured image.

In step 302, the ATM 106 may store product data in the product database 208 as one or more product data entries 210. Each product data entry may include at least a product identifier, product data, and one or more product characteristics. The product data may include, for example, product name, product description, purchase amount, dimensions, color information, size information, shipping information, manufacturer data, etc.

In step 304, the imaging unit 216 of the ATM 106 may be configured to capture an image of the consumer 102. In step 306, the processing unit 204 of the ATM 106 may be configured to analyze the captured image to identify a plurality of characteristics. The plurality of characteristics may include characteristics of clothing or accessories worn by the consumer 102, items carried by the consumer 102, facial or physical features of the consumer 102, characteristics of the surrounding area, etc. In some embodiments, step 304 may be initiated by the consumer 102, such as upon the insertion of the payment card 104 into the ATM 106.

In step 308, the processing unit 204 may analyze each of the product data entries 210 for a correspondence between the included product characteristic(s) and the plurality of characteristics analyzed in the captured image. If there is a match for the product, then, in step 310, the product data included in the product data entry 210 may be added to a list of advertised and/or offered products that is to be displayed to the consumer 102. If there is not a match for the product, then, in step 312, the corresponding product data is not added to the list of products to be advertised and/or offered to the consumer 102.

Once the product data for each matching product has been added, then, in step 314, the processing unit 204 may determine if the product data is to be filtered. The determination may be based on internal rules (e.g., stored in the memory 212), data provided by the financial institution 108, input received from the consumer 102, or other suitable basis. In one embodiment, the product may be filtered upon the existence of one or more filtering criteria (e.g., consumer data), but may not be filtered if no such criteria is identified.

If the product data is to be filtered, then, in step 316, the reading unit 220 may read the payment details encoded in the payment card 104 inserted in the ATM 106. In step 318, the ATM 106 may identify an account profile associated with the payment card 106 based on the payment details. In some embodiments, the account profile may be identified as stored in an account database or the memory 212. In other embodiments, the transmitting unit 206 of the ATM 106 may transmit the payment details to the financial institution 108, and the receiving unit 202 of the ATM 106 may receive account details for the payment account from the financial institution 108. Then, in step 320, the processing unit 204 may filter products in the list of products to be displayed based on characteristics of the payment account and/or consumer 102 based on the account profile.

Once the products have been filtered, or if no filtering takes place, then, in step 322, the processing unit 204 may determine if the list of products should be ranked. The determination may be based on, for instance, rules stored in the memory 212, or any other suitable criteria. If the products should be ranked, then, in step 324, the processing unit 204 may rank the products based on strength of the correspondence between the product characteristics and the characteristics identified in the captured image. In instances where consumer or account data is available, the ranking may be further based on such data. Once the products are ranked, or if no ranking is necessary, then, in step 326, the display unit 214 of the ATM 106 may display the finalized (e.g., filtered and/or ranked) list of products to the consumer 102 for selection of purchasing.

### Process for Selection of a Payment Account

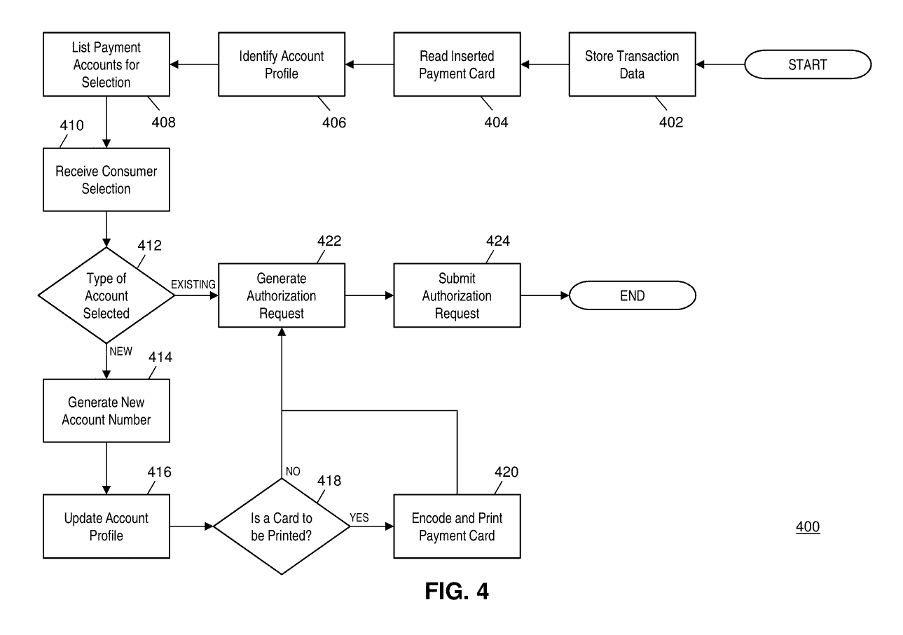

FIG. 4 illustrates a process 400 for the selection of a payment account among a plurality of payment accounts at the ATM 106 for the funding of a payment transaction.

In step 402, the processing unit 204 of the ATM 106 may store transaction data for a payment transaction being conducted in the memory 212 of the ATM 106. The transaction data may include, for example, product data, a transaction amount, shipping data, merchant data, etc. In step 404, the reading unit 220 of the ATM 106 may read the payment card 104 inserted into the ATM 106 to identify payment details encoded therein. In step 406, the processing unit 204 may identify an account profile associated with the payment card 104 based on the encoded payment details.

In some embodiments, identification of the account profile may include identifying an account profile stored in the memory 212 or an account database that includes an account identifier corresponding to an account identifier encoded in the payment card 104 and read by the reading unit 220. In other embodiments, identification of the account profile may include transmitting the account identifier read from the payment card 104 to the financial institution 108 by the transmitting unit 206 of the ATM 106, and receipt of the account profile by the receiving unit 202 of the ATM 106 as a response from the financial institution 108.

Once the account profile has been identified, then, in step 408, the display unit 214 of the ATM 106 may display a list of payment accounts for selection by the consumer 102. The list of payment accounts may include the payment account corresponding to the inserted payment card 104 and any other payment accounts included in the identified account profile. In some embodiments, the list of payment accounts may include an option to open a new payment account or be issued a new payment instrument to be used to fund the payment transaction.

In step 410, the input unit 218 of the ATM 106 may receive a selection from the consumer 102, selecting one of the options display to the consumer 102. In step 412, the processing unit 204 may determine if the selection by the consumer 102 is for an existing payment account or for a new payment account or payment instrument. If the selection is for a new account, then, in step 414, the processing unit 204 may generate a new payment account number and/or payment details as required for the opening of the new payment account and/or payment instrument. In some embodiments, generating the new payment account number may include submitting a request for a new payment account number to the financial institution 108 and receipt thereof.

Once the new account number has been identified, then, in step 416, the processing unit 204 may update the account profile to include the new account number for use in future payment transactions. In step 418, the processing unit 204 may determine if a payment instrument, such as a new payment card 104, is to be printed for the consumer 102. The determination may be based on internal rules stored in the memory 212, instructions from the financial institution 108, the type of account or payment instrument issued, requests from the consumer 102, and other suitable criteria. If printing is to determined be performed, then, in step 420, the printing unit of the ATM 106 may print the corresponding payment card encoded with payment details, or other payment instrument based on the newly opened account, such as a letter of credit, check, etc.

Once a new account has been established for payment or if an existing account has been selected for payment in step 412, then, in step 422, the processing unit 204 may generate an authorization request for the payment transaction. The authorization request may include the stored transaction data and payment details corresponding to the selected (e.g., previously existing and/or newly generated) payment account. In step 424, the transmitting unit 206 of the ATM 106 may submit the generated authorization request to the payment network 110 for processing.

### Graphical User Interfaces

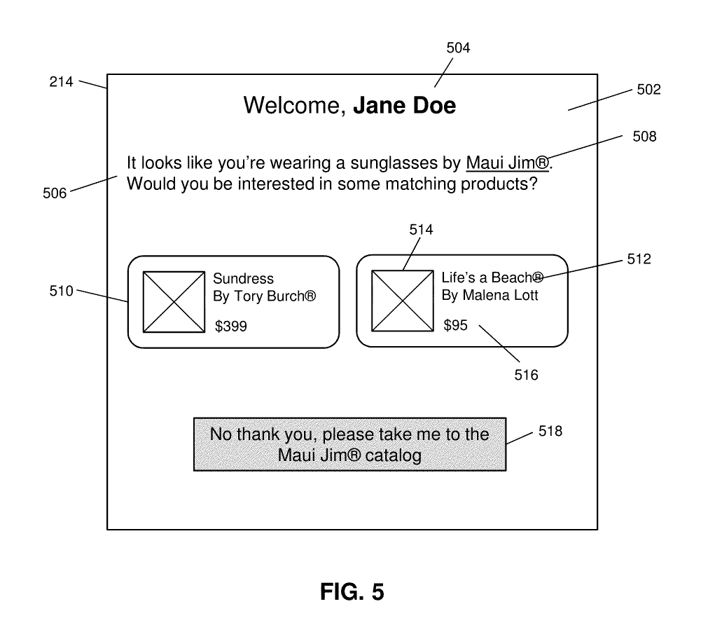

FIGS. 5-7 illustrate exemplary graphical user interfaces of the ATM 106 suitable for performing some of the functions disclosed herein. It will be apparent to persons having skill in the relevant art that the interfaces illustrated and described herein are for illustrative purposes only, and that other interfaces and display configurations may be suitable for performing the functions disclosed herein.

FIG. 5 illustrates an example interface displayed by the display unit 214 of the ATM 106 for the presentation of products for purchase by the consumer 102 based on characteristics of a captured image. In the example interface, the display unit 214 may display a product screen 502. The product screen 502 may include consumer name 504, which may indicate to the consumer 102 that they have been properly identified, such as based on data encoded in the payment card 104.

The product screen 502 may also include a message 506. In the illustrated example, the message 506 may indicate to the consumer 102 that analysis of a captured image detected a product 508, such as a specific fashion brand in the example. The product screen 502 may further include suggested products 510. Each suggested product 510 may correspond to a product data entry 210 identified by the processing unit 204 as corresponding to the detected product 508, such as based on the fashion brand.

Each suggested product 510 may include product data associated with the product to be presented to the consumer 102. In the example illustrated in FIG. 5, the suggested product 510 may include a product name 512, a product image 514, and a purchase price 516. In some embodiments, each suggested product 510 may be a selectable item such that interacting with the item (e.g., via the display unit 214 as an input device) will view more details regarding the item and/or initiate a payment transaction for the product.

The product screen 502 may also include a button 518. Consumer interaction with the button 518 may indicate that the consumer 102 is not interested in any of the suggested products 510, and may initiate display of a product catalog, menu of options, or other type of interface as will be apparent to persons having skill in the relevant art.

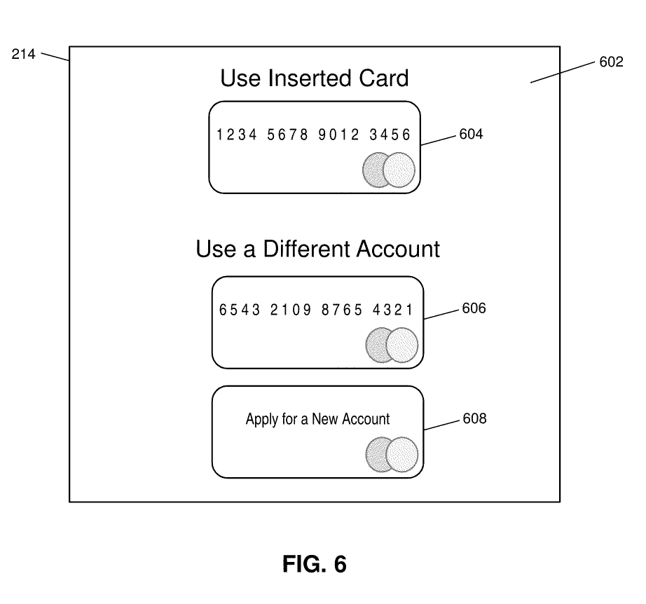

FIG. 6 illustrates an example interface of the selection of one of a plurality of payment accounts by the consumer 102 using the ATM 106. The display unit 214 may display an account selection screen 602. The account selection screen 602 may include a first account 604. The first account 604 may correspond to the payment account associated with the payment card 104 inserted into the ATM 106. Account details associated with the first account 604 may displayed to the consumer 102, such as the account number as illustrated in FIG. 6, available credit, potential rewards, earned rewards, etc.

The account selection screen 602 may also include one or more alternative accounts 606. Each alternative account 606 may correspond to an alternative payment account associated with the consumer 102 based on the account profile of the consumer 102 that includes the payment account corresponding to the first account 604. The account selection screen 602 may also include a new account button 608. The new account button 608, when interacted with by the consumer 102, may initiate the generation of a new payment account or payment instrument for the consumer 102 to be used to fund the payment transaction.

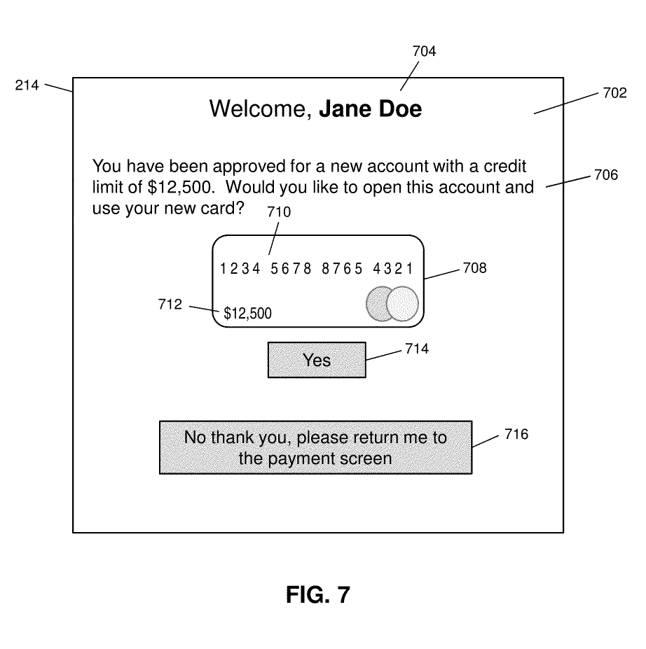

FIG. 7 illustrates an example interface of the creation of a new payment account using the ATM 106 for funding a payment transaction, such as to be presented to the consumer 102 upon interaction with the new account button 608 illustrated in FIG. 6. The display unit 214 may display an account creation screen 702. The account creation screen 702 may include the consumer name 704 and a message 706. The message 706 may indicate that the consumer 102 has been approved for a new payment account and may include details regarding the approval. In the example illustrated in FIG. 7, the message 706 indicates that the consumer 102 has been approved for a new account with a credit limit of $12,500.

The account creation screen 702 may further include a card representation 708. The card representation 708 may be a graphical representation of a payment card corresponding to the approved payment account, to be displayed to the consumer 102. The card representation 708 may include a new account number 710 to be associated with the approved payment account upon acceptance and a credit limit 712 associated with the approved payment account, such as indicated in the message 706.

The account creation screen 702 may also include an approval button 714. Upon interaction with the approval button 714, the ATM 106 may begin a process for the creation of the new payment account and use thereof to fund the payment transaction, such as by using the methods and systems discussed herein. The account creation screen 702 may also include a decline button 716. The decline button 716, when interacted with, may return the consumer 102 to the account selection screen 602 where the consumer 102 can select an alternative method of payment to fund the payment transaction.

### Exemplary Method for Processing Payment Transactions at an Automated Teller Machine

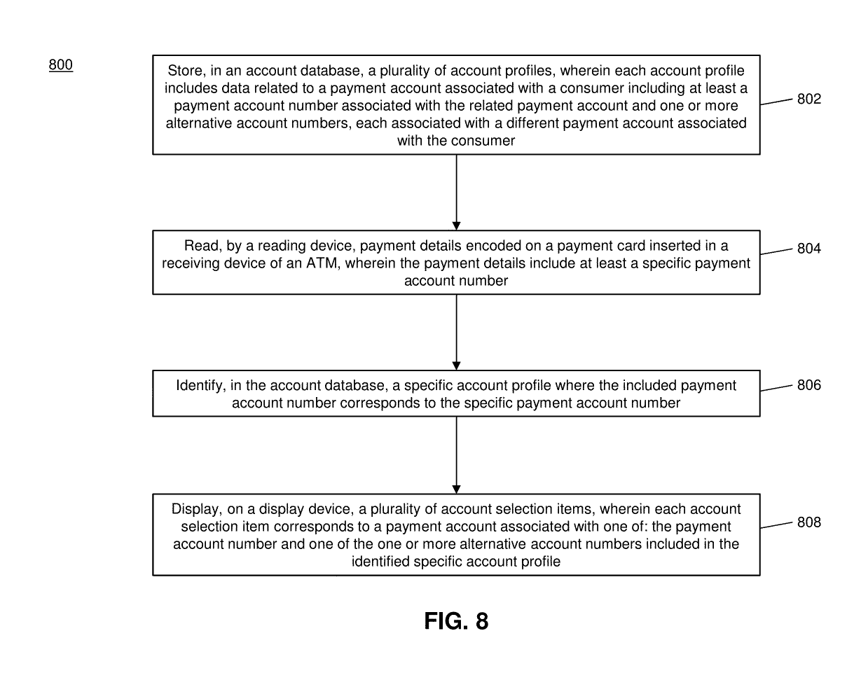

FIG. 8 illustrates a method 800 for the processing of payment transactions at an automated teller machine (ATM) via the selection of a payment account among a plurality of payment accounts.

In step 802, a plurality of account profiles may be stored in an account database, wherein each account profile includes data related to a payment account associated with a consumer (e.g., the consumer 102) including at least a payment account number associated with the related payment account and one or more alternative account numbers, each associated with a different payment account associated with the consumer 102. In step 804, payment details encoded on a payment card (e.g., the payment card 104) inserted in a receiving device (e.g., the receiving unit 202) of an ATM (e.g., the ATM 106) may be read by a reading device (e.g., the reading unit 220), wherein the payment details include at least a specific payment account number.

In step 806, a specific account profile may be identified in the account database where the included payment account number corresponds to the specific payment account number. In step 808, a plurality of account selection items may be displayed on a display device (e.g., the display unit 214), wherein each account selection item corresponds to a payment account associated with one of: the payment account number and one of the one or more alternative account numbers included in the identified specific account profile.

In one embodiment, the method 800 may further include: storing, in a memory (e.g., the memory 212), transaction details for a payment transaction; receiving, by an input device (e.g., the input unit 218), an indication of one of the plurality of account selection items; generating, by a processing device (e.g., the processing unit 204), an authorization request for the payment transaction, wherein the authorization request includes at least the stored transaction details and the payment account number or one of the one or more alternative account numbers associated with the payment account corresponding to the indicated one of the plurality of account selection items; and transmitting, by a transmitting device (e.g., the transmitting unit 206), the generated authorization request. In a further embodiment, the method 800 may even further include printing, by a printing device, a voucher associated with the payment transaction suitable for presentation to a merchant involved in the payment transaction in exchange for one or more products.

In some embodiments, the plurality of account selection items may include a new selection item, and the method 800 may further include: storing, in the memory 212, transaction details for a payment transaction; receiving, by the input device 218, an indication of the new account selection item; generating, by the processing device 204, a new account number corresponding to a new payment account to be associated with the consumer 102; generating, by the processing device 204, an authorization request for the payment transaction, wherein the authorization request includes at least the stored transaction details and the new account number; and transmitting, by the transmitting device 206, the generated authorization request.

In a further embodiment, the method 800 may even further include printing, by a printing device, a payment instrument associated with the new payment account, wherein the payment instrument includes at least the generated new account number. In another further embodiment, the method 800 may also include updating, in the account database, the one or more alternative account numbers in the specific account profile to include the generated new account number.

### Exemplary Method for Presenting Products for Purchase at an Automated Teller Machine

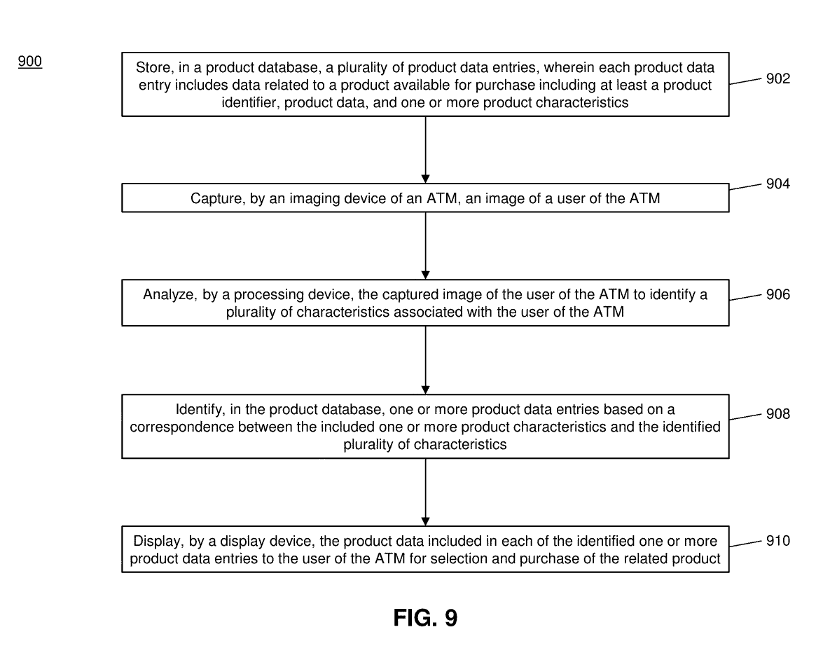

FIG. 9 illustrates a method 900 for the presentation of products for purchase at an automated teller machine (ATM) based on analysis of a captured image of a user of the ATM.

In step 902, a plurality of product data entries (e.g., product data entries 210) may be stored in a product database (e.g., the product database 208), wherein each product data entry 210 includes data related to a product available for purchase including at least a product identifier, product data, and one or more product characteristics. In step 904, an imaging device (e.g., the imaging unit 216) of an ATM (e.g., the ATM 106) may capture an image of a user (e.g., the consumer 102) of the ATM 106. In step 906, the captured image of the user 102 of the ATM 106 may be analyzed by a processing device (e.g., the processing unit 204) to identify a plurality of characteristics associated with the user 102 of the ATM 106.

In step 908, one or more product data entries 210 may be identified in the product database 208 based on a correspondence between the included one or more product characteristics and the identified plurality of characteristics. In step 910, the product data included in each of the identified one or more product data entries 210 may be displayed to the user 102 of the ATM 106 by a display device (e.g., the display unit 214) for selection and purchase of the related product.

In one embodiment, the method 900 may further include: storing, in an account database, a plurality of account profiles, wherein each account profile includes data related to a payment account associated with a consumer (e.g., the consumer 102) including at least a payment account number associated with the related payment account and a plurality of consumer characteristics; reading, by a reading device (e.g., the reading unit 220), payment details encoded on a payment card (e.g., the payment card 104) inserted into a receiving device (e.g., the receiving unit 202) of the ATM 106, wherein the payment details include at least a specific payment account number; and identifying, in the account database, a specific account profile where the included payment account number corresponds to the specific payment account number, wherein the identified one or more product data entries 210 is further based on a correspondence between the included one or more product characteristics and the plurality of consumer characteristics included in the identified specific account profile.

In a further embodiment, the plurality of consumer characteristics may include at least one of: transaction data for a plurality of payment transactions involving the associated consumer 102, consumer preferences, and purchase behavior. In some embodiments, the plurality of characteristics associated with the user 102 of the ATM 106 may include at least one of: facial recognition characteristics, clothing characteristics, jewelry characteristics, and accessory characteristics. In one embodiment, the identified plurality of characteristics associated with the user 102 of the ATM 106 may not be personally identifiable.

### Computer System Architecture

FIG. 10 illustrates a computer system 1000 in which embodiments of the present disclosure, or portions thereof, may be implemented as computer-readable code. For example, the ATM 106 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 8, and 9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (H DMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 4, 8, and 9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for processing payment transactions and presenting products for purchase at an ATM. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing payment transactions at an automated teller machine (ATM), comprising:
storing, in an account database, a plurality of account profiles, wherein each account profile includes data related to a payment account associated with a consumer including at least a payment account number associated with the related payment account and one or more alternative account numbers, each associated with a different payment account associated with the consumer;
reading, by a reading device, payment details encoded on a payment card inserted in a receiving device of an ATM, wherein the payment details include at least a specific payment account number;
identifying, in the account database, a specific account profile where the included payment account number corresponds to the specific payment account number;
displaying, on a display device, a plurality of account selection items, wherein each account selection item corresponds to a payment account associated with one of: the payment account number and one of the one or more alternative account numbers included in the identified specific account profile;
receiving, by an input device, an indication of one of the one of the displayed plurality of account selection items;
generating, by a processing device, an authorization request for a payment transaction, wherein the authorization request includes at least transaction details and the payment account number or one of the one or more alternative account numbers corresponding to the indicated one of the plurality of account selection items; and
transmitting, by a transmitting device, the generated authorization request.

2. The method of claim 1, further comprising:
storing, in a memory, the transaction details for the payment transaction.

3. The method of claim 1, further comprising:
printing, by a printing device, a voucher associated with the payment transaction suitable for presentation to a merchant involved in the payment transaction in exchange for one or more products.

4. The method of claim 1, wherein
the plurality of account selection items further includes a new account selection item,
the received indication of one of the displayed plurality of account selection items indicates the new account selection item, and
the method further comprises:
generating, by a processing device, a new account number corresponding to a new payment account to be associated with the consume, wherein the generated authorization request includes the generated new account number.

5. The method of claim 4, further comprising:
printing, by a printing device, a payment instrument associated with the new payment account, wherein the payment instrument includes at least the generated new account number.

6. The method of claim 4, further comprising:
updating, in the account database, the one or more alternative account numbers in the specific account profile to include the generated new account number.

7. A method for presenting products for purchase at an automated teller machine (ATM), comprising:
storing, in a product database, a plurality of product data entries, wherein each product data entry includes data related to a product available for purchase including at least a product identifier, product data, and one or more product characteristics;
capturing, by an imaging device of an ATM, an image of a user of the ATM;
analyzing, by a processing device, the captured image of the user of the ATM to identify a plurality of characteristics associated with the user of the ATM;
identifying, in the product database, one or more product data entries based on a correspondence between the included one or more product characteristics and the identified plurality of characteristics; and
displaying, by a display device, the product data included in each of the identified one or more product data entries to the user of the ATM for selection and purchase of the related product.

8. The method of claim 7, further comprising:
storing, in an account database, a plurality of account profiles, wherein each account profile includes data related to a payment account associated with a consumer including at least a payment account number associated with the related payment account and a plurality of consumer characteristics;
reading, by a reading device, payment details encoded on a payment card inserted in a receiving device of the ATM, wherein the payment details include at least a specific payment account number; and
identifying, in the account database, a specific account profile where the included payment account number corresponds to the specific payment account number, wherein
the identified one or more product data entries is further based on a correspondence between the included one or more product characteristics and the plurality of consumer characteristics included in the identified specific account profile.

9. The method of claim 8, wherein the plurality of consumer characteristics includes at least one of: transaction data for a plurality of payment transactions involving the associated consumer, consumer preferences, and purchase behavior.

10. The method of claim 7, wherein the plurality of characteristics associated with the user of the ATM may include at least one of: facial recognition characteristics, clothing characteristics, jewelry characteristics, and accessory characteristics.

11. The method of claim 7, wherein the identified plurality of characteristics associated with the user of the ATM are not personally identifiable.

12. An automated teller machine (ATM) for processing payment transactions, comprising:
a receiving device;
a transmitting device;
an account database configured to store a plurality of account profiles, wherein each account profile includes data related to a payment account associated with a consumer including at least a payment account number associated with the related payment account and one or more alternative account numbers, each associated with a different payment account associated with the consumer;
a reading device configured to read payment details encoded on a payment card inserted in the receiving device, wherein the payment details include at least a specific payment account number;
a processing device configured to identify, in the account database, a specific account profile where the included payment account number corresponds to the specific payment account number;
a display device configured to display a plurality of account selection items, wherein each account selection item corresponds to a payment account associated with one of: the payment account number and one of the one or more alternative account numbers included in the identified specific account profile; and
an input device configured to receive an indication of one of the one of the displayed plurality of account selection items, wherein
the processing device is further configured to generate an authorization request for a payment transaction, wherein the authorization request includes at least transaction details and the payment account number or one of the one or more alternative account numbers corresponding to the indicated one of the plurality of account selection items, and
the transmitting device is configured to transmit the generated authorization request.

13. The automated teller machine of claim 12, further comprising:
a memory configured to store the transaction details for the payment transaction.

14. The automated teller machine of claim 13, further comprising:
a printing device configured to print a voucher associated with the payment transaction suitable for presentation to a merchant involved in the payment transaction in exchange for one or more products.

15. The automated teller machine of claim 12, wherein
the plurality of account selection items further includes a new account selection item,
the received indication of one of the displayed plurality of account selection items indicates the new account selection item,
the processing device is further configured to generate a new account number corresponding to a new payment account to be associated with the consumer, and
the generated authorization request includes the generated new account number

16. The automated teller machine of claim 15, further comprising:
a printing device configured to print a payment instrument associated with the new payment account, wherein the payment instrument includes at least the generated new account number.

17. The automated teller machine of claim 15, wherein the processing device is further configured to update, in the account database, the one or more alternative account numbers in the specific account profile to include the generated new account number.

18. An automated teller machine (ATM) for presenting products for purchase, comprising:
a product database configured to store a plurality of product data entries, wherein each product data entry includes data related to a product available for purchase including at least a product identifier, product data, and one or more product characteristics;
an imaging device configured to capture an image of a user of the ATM;
a processing device configured to
analyze the captured image of the user of the ATM to identify a plurality of characteristics associated with the user of the ATM, and
identify, in the product database, one or more product data entries based on a correspondence between the included one or more product characteristics and the identified plurality of characteristics; and
a display device configured to display the product data included in each of the identified one or more product data entries to the user of the ATM for selection and purchase of the related product.

19. The automated teller machine of claim 18, further comprising:
an account database configured to store a plurality of account profiles, wherein each account profile includes data related to a payment account associated with a consumer including at least a payment account number associated with the related payment account and a plurality of consumer characteristics; and
a reading device configured to read payment details encoded on a payment card inserted in a receiving device of the ATM, wherein the payment details include at least a specific payment account number, wherein
the processing device is further configured to identify, in the account database, a specific account profile where the included payment account number corresponds to the specific payment account number, and
the identified one or more product data entries is further based on a correspondence between the included one or more product characteristics and the plurality of consumer characteristics included in the identified specific account profile.

20. The automated teller machine of claim 19, wherein the plurality of consumer characteristics includes at least one of: transaction data for a plurality of payment transactions involving the associated consumer, consumer preferences, and purchase behavior.

21. The automated teller machine of claim 18, wherein the plurality of characteristics associated with the user of the ATM may include at least one of: facial recognition characteristics, clothing characteristics, jewelry characteristics, and accessory characteristics.

22. The automated teller machine of claim 20, wherein the identified plurality of characteristics associated with the user of the ATM are not personally identifiable.
